(19) United States
(12) Patent Application Publication
(10) Pub. No.: US 2021/0308501 A1
(43) Pub. Date: Oct. 7, 2021

(54) RESPIRATOR FILTER

(71) Applicant: Alberta Centre for Advanced MNT Products, Edmonton (CA)

(72) Inventors: Ken BRIZEL, Edmonton (CA); Viet HOANG, Edmonton (CA); William CULLY, Edmonton (CA)

(21) Appl. No.: 17/220,386

(22) Filed: Apr. 1, 2021

Related U.S. Application Data
(60) Provisional application No. 63/003,398, filed on Apr. 1, 2020.
(60) Provisional application No. 63/080,177, filed on Sep. 18, 2020.

(51) Int. Cl. A62B 23/02; D01F 6/62; D01F 1/10; D04H 1/4382

(52) U.S. Cl. CPC A62B 23/02; D04H 1/4382; D01F 1/10; D01F 6/62

(57) ABSTRACT

A respirator or mask includes a filtration medium including a fabric which is a non-woven or knit fabric having a mixture of natural and synthetic fibres.

### CROSS-REFERENCE TO RELATED APPLICATIONS

This application claims the priority benefit of US Provisional Patent Application Nos. 63/003,398, filed on Apr. 1, 2020 and 63/080,177, filed on Sep. 18, 2020, and the entire contents of both are incorporated herein.

### FIELD OF THE INVENTION

The present invention relates to a respirator mask and filtration media for use in a respirator mask.

### BACKGROUND

The filtration of aerosols from inhaled or exhaled air is important in reducing airborne transport of viral pathogens. The most difficult particles to filter, sometimes referred to as the most penetrating particles, typically have diameters somewhere in the 100 to 1000 nm range. Droplets produced during exhalation while breathing and speaking have a wide range of sizes, but do include particles in the most penetrating particle range, particularly after such droplets have evaporated down to become droplet nuclei in ambient air. Respirators, also called masks, use filtration media to filter out a certain fraction of aerosols during breathing, and are recommended for those wanting protection against airborne viral threats. Different levels of protection are provided by different respirators depending on the filtration efficiency of the filters used. Commonly recommended N95 respirators use filtration media that removes >95% of the most penetrating particles.

There is a need in the art for masks and filtration media which are simple and quick to manufacture, to meet sudden and increased demand where necessary.

### SUMMARY OF THE INVENTION

In one aspect, the invention comprises a respirator filtration medium comprising a fabric comprising a non-woven or knit fabric comprising a mix of natural and synthetic fibers, preferably in multiple layers. In some embodiments, the fabric comprises a knit fleece having a mix of cotton and polyester fibres, where one side of the fabric is brushed and sheared to create a pile layer.

In another aspect, the invention may comprise a method of cleaning and reusing the filtration medium, including the step of deionizing the medium, preferably with a mixture of random ions.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 is a photograph of a 50/50 polyester/cotton fleece fabric.

FIG. 2 is a graph showing filtration efficiency for various fabrics.

FIG. 3 is two graphs showing filtration efficiency for 5-layer fabrics after ion gun treatment.

FIG. 4 shows filtration efficiency of 5-layer filters for three different ion gun treatment methods.

FIG. 5 shows pressure drop of 5-layer filters after MI-II and ion gun treatment.

### DETAILED DESCRIPTION

The present invention may be embodied in a filtration medium comprising a fabric comprising a non-woven or knit fabric comprising a mixture of natural and synthetic fibres, preferably in multiple layers. The filtration medium may be fashioned or incorporated into a respirator or mask using conventional methods.

A fabric comprising 100% cotton threads acts as a filter but to achieve 90% or better filtration efficiency, extremely thick material layers are required, which in turn makes it difficult to breathe through (large pressure drop). A fabric comprising 100% polyester threads is not breathable even in thin layers. The inventors have found that a fabric comprising a mixture of natural and synthetic threads provides useful filtration and pressure drop properties. In some embodiments, the proportion of natural fibers to synthetic fibers may range from about 20-80 to about 80-20.

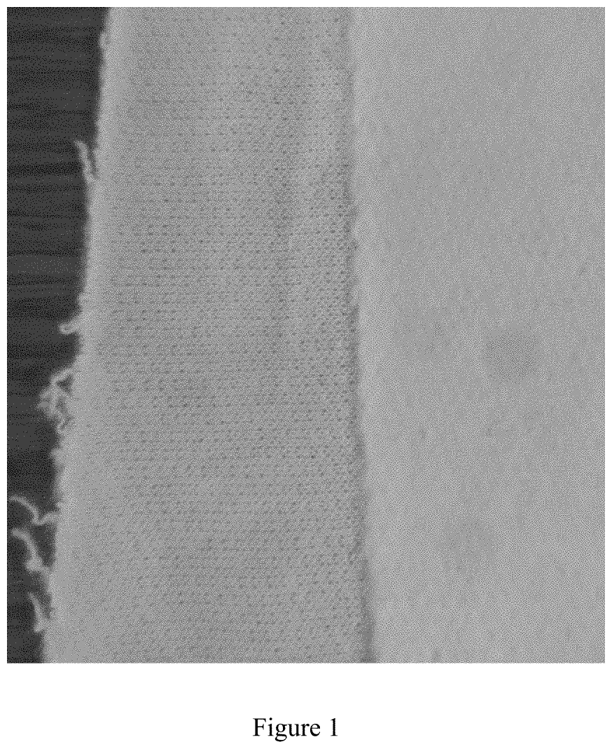

In some embodiments, the fabric comprises conventional garment fleece fabric comprising a blend of polyester and cotton. Fleece fabric is a knit fabric where at least one side is brushed to loosen fibers and create a nap (raised surface) for a soft, plush feel. The raised fibers may be sheared to create a fluffy pile surface. FIG. 1 shows a fleece fabric with a knit surface and a brushed surface.

In one specific embodiment, the fabric comprises a 50%/50% blend of a synthetic polymer and a natural fiber such as cotton. Suitable synthetic fibers may include polyester, nylon, acrylic or polyolefin. Suitable natural fibers may include cotton, flax, hemp, jute, sisal, silk, wool or other fibres of plant or animal origin. Without restriction to a theory, it is believed that a significant proportion of a synthetic polymer, such as polyester, results in a buildup of electrostatic charge in the fabric as the cotton is slightly positive electrostatically and polyester is slightly negative electrostatically thus creating a dipole. This small electrostatic charge may result in airborne aerosols and particles being attracted to and retained by the fabric as air moves through the fabric.

The fabric preferably is a mid-weight fabric, which provide a suitable combination of filtering ability and airflow (minimal pressure drop). Typical garment fabric in the range of 5-14 oz/yd² may be used, and preferably 10 to 12 oz fabric. Representative fabric weights are shown in the table below. Fabric weight is a function of the thread thickness, thread composition, and the tightness of the fabric weave. Lighter fabrics may be combined in a greater number of layers to be the functional equivalent of heavier fabrics in fewer layers.

| Fabric | | | | |
|---|---|---|---|---|
| Weight | OSY | GSM | Thread | Needle |
| Extra | 2 oz.-4 oz. | 8 g-136 g | 80 wt.-60 wt. | 60/8, 65/9 |
| Light | | | | |
| Light | 4 oz.-6 oz. | 136 g-204 g | 60 wt.-50 wt. | 70/10, 75/11 |
| Medium | 6 oz.-8 oz. | 204 g-272 g | 50 wt.-40 wt. | 75/11, 80/12 |
| Medium | 8 oz.-10 oz. | 272 g-339 g | 50 wt.-40 wt. | 80/12, 90/14 |
| Heavy | | | | |
| Heavy | 10 oz.-12 oz. | 339 g-407 g | 40 wt.-30 wt. | 100/16, 110/18 |
| Extra | 12 oz.-14 oz. | 407 g-475 g | 30 wt.-20 wt. | 110/18, 120/19 |
| Heavy | | | | |

OSY = ounces per square yard
GSM = grams per square metre

The filtration medium may comprise multiple layers of the fabric, such as 2 to 15 single layers, depending on fabric weight and tightness of the knit. Adjacent layers may optionally be adhered to each other by spot adhesives.

Without restriction to a theory, it is believed that the brushed and/or sheared feature of preferred fleece fabrics may produce local electrical fields which are randomly oriented, as a result of the random orientation of the natural and synthetic fibers in the fabric being brushed and sheared into a fabric pile.

In another aspect, the invention may comprise a method of cleaning and reusing filtration media for use in a respirator mask. It is known to decontaminate material using moist heat, with or without cleaning or sterilizing compositions. The inventors have found that simple moist heat incubations resulted in reduced filtration efficiency. Therefore, in some embodiments, the invention comprises a method of cleaning and reusing filtration media, by applying moist heat incubation (MHI) for a suitable length of time, and treating the media with an ion gun.

In some embodiments, MHI may be applied for between about 10 minutes to about 60 minutes, and at a temperature of between about 40° C. to about 100° C., with relatively humidity in the range of about 60% to 100%. The specific MHI conditions are not an essential element of this invention.

Ion guns are well known in the art of semiconductor manufacturing, and comprise devices which emits ions at a substrate, to reduce electrostatic charge. It can be used to deionize charged materials. After MHI treatment, filtration medium has uneven and varied electrostatic charges. The inventors have found that a brief deionizing treatment restores at least partially the pre-treatment filtration efficiency. Without restriction to a theory, it is believed that pockets of predominantly positive or negative charges are detrimental to filtration efficiency, and that deionizing treatment restores the overall neutrality of the material, where randomly dispersed and oriented dipoles may enhance filtration efficiency.

For example, deionization with a field of random ions generated by an ion gun for a period of between about a few seconds to a few minutes may beneficial.

### EXAMPLES

After a single cycle of separate MHI decontamination, 15-minute MHI resulted in ˜5% decrease in filtration efficiency for 5-layer filters, while 30-minute MHI decreased filtration efficiency by ˜14% at most penetrating particle size. Ion gun treatment was shown to increase filtration efficiency, although this effect was countered by preconditioning filters to high humidity. Considering the temporary effect of ion gun treatment, the filtration efficiency of S-layer filters after 15-minute MHI and ion gun treatment can be conservatively estimated to range between 75% to 91% at the most penetrating particle size.

Fabric

The filter media consisted of 50% polyester/50% cotton knit fleece material, with a weight of 12.6 oz, with one side brushed and sheared to produce a pile, as is well known in the art. Multilayer filters were assembled with pile side to adjacent to a woven side.

Testing Methods

Previously developed measurement methods (Mao et al. 2008, Tavernini et al. 2018) were modified to measure aerosol filtration and pressure drop across filtration media samples. Briefly, the procedure involves nebulizing isotonic saline to produce liquid droplets containing NaCl in solution. These droplets are passed through a Kr-85 charge neutralizer, then dried by passing them through a drying column to produce a challenge aerosol that contains a range of dry particle diameters that includes diameters associated with the most penetrating particles. The basic procedure is also part of standardized testing described in NIOSH-42 CFR Part 84 that is required for certification of N95 respirators.

The challenge aerosol was supplied to a plenum after flowing through flow straighteners and allowed to become well mixed before being drawn through either a blank line or a line containing the filter sample. An Electrical Low Pressure Impactor (ELPI) placed downstream continuously measured aerosol concentration, C, as a function of aerodynamic particle size in discrete size range bins for a flow rate of 30 l/min. For the sake of expediency, corrections in aerodynamic diameter due to the variation of Cunningham slip factor with density have been ignored, since these corrections are minor. The filtration efficiency was then determined as

E=100*(1-Cin/Cout) (1)

where Cin is the concentration in the blank line and Cout is the concentration after the filter.

All samples were nominally 3″33 3″ in size, although actual face area exposed to aerosol was somewhat less due to pinching of the material around the perimeter where the samples are secured for an airtight seal.

MHI Decontamination

For the MHI separate group, filters were exposed to a temperature of 60° C. and relative humidity of 80% for 30 minutes in a temperature & humidity chamber (Espec SH-241), then dried at 60° C. without humidity control for 30 minutes in a temperature chamber (Espec BTZ-175). Filters were tested within 6 hours after decontamination.

For the MHI batch group, a batch of filters were exposed to temperature and humidity ramping up from ambient to the target temperature of 60° C. and relative humidity of 80% for 30 minutes and then held at the fixed target temperature and relative humidity for an additional 30 minutes. Filters were then dried at 60° C. without humidity control for 30 minutes. Three random filters were selected from the batch for test. Filters were tested between 8 to 16 day after decontamination.

An ion gun (SIMCOTM Ion Top Gun) was applied to filters through three different scenarios shown in Table 1. The electrostatic potential (voltage) above the filters was evaluated with an ACL 350 Digital Static Locator.

TABLE 1
Three scenarios used for ion gun application

| Ion Gun | | Containment |
|---|---|---|
| Application | | during |
| Method | Gun Exposure Time | Transportation |
| YES ion | 30 s onto unfolded filters; once | Anti-static bags |
| | filters are re-folded, additional | |
| | 30 seconds | |
| YES ion | 10 s onto folded filters placed | Plastic Ziploc bag |
| 10 s in bag | in a plastic Ziploc bag | |
| | (gun pointing into the bag) | |
| YES ion | 10 s with filters folded and fitted | Filters fitted to |
| 10 s in mask | in ACAMP A90/95 mask body | the mask body and |
| | (gun pointing into the mask | placed in a plastic |
| | assembly) | Ziploc bag |

“Worst-Case” Scenario (Preconditioning)

In order to test the lasting effect of ion gun treatment, filters were exposed to a temperature of 38° C. and relative humidity of 85% for 25 hours in a temperature & humidity chamber (Espec SH-241), which emulates a conservative “worst-case” condition that could result from storage conditions or during use over long time periods. This temperature and humidity preconditioning is specified in 42-CFR Part 84. This filter group (“preconditioned” or “precon” hereinafter) were tested within 6 hours after preconditioning.

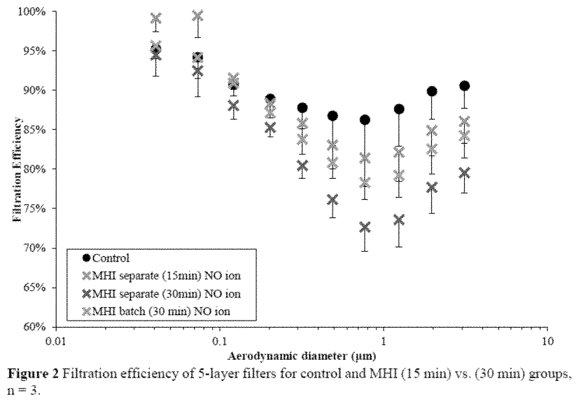

FIG. 2 summarizes filtration efficiencies measured for control (without MHI and without ion gun treatment) and MHI (15 min) vs. (30 min) for 5-layer filters. Comparing MHI separate (15 min) and (30 min), results suggests that shorter exposure to the decontamination conditions decreases filtration efficiencies less: 15-minute MHI led to ˜5% decrease in filtration efficiency and 30-minute exposure led to ˜14% decrease in filtration efficiency at the most penetrating particle size.

Comparing MHI separate and MHI batch, an additional 30 minutes in batch decontamination did not degrade efficiency further. MHI batch filters yielded similar or higher efficiencies as the 30 minute MHI separate case. See Table 2 for the filtration efficiency drop at the most penetrating particle size for each type.

TABLE 2
Most penetrating aerodynamic diameter and corresponding
filtration efficiency for MHI (15 min) vs. (30 min)

| | | MHI | MHI | MHI |
|---|---|---|---|---|
| | | separate | separate | batch |
| | | (15 min) | (30 min) | (30 min) |
| | Control | NO ion | NO ion | NO ion |
| Most Penetrating | 0.768 | 0.768 | 0.768 | 0.768 |
| Aerodynamic Diameter | | | | |
| (μm) | | | | |
| Filtration at Most | 86.3% | 81.4% | 72.7% | 78.3% |
| Penetrating Diameter | | | | |
| Efficiency Drop after | N/A | −4.9% | −13.6% | −8% |
| Single-cycle MHI | | | | |

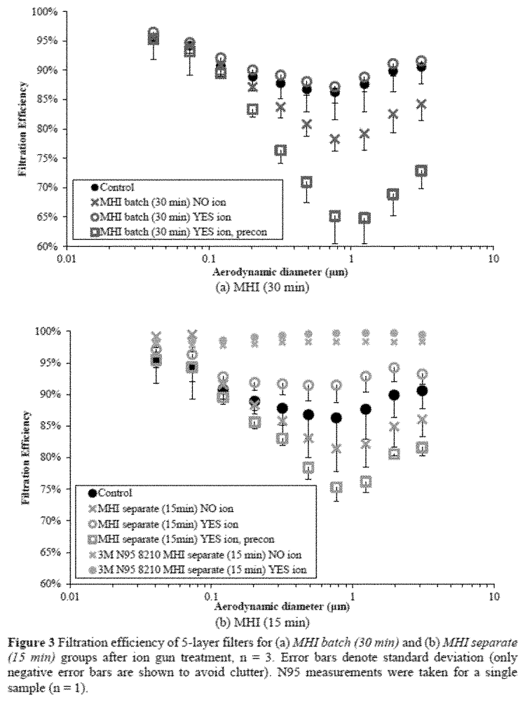

FIG. 3 summarizes filtration efficiencies measured for MHI without (NO ion) and with ion gun treatment (YES ion). The filtration efficiency of 3M™ N95 8210 mask after 15-minute MHI with and without ion gun treatment was tested for reference. Ion gun treatment appears to increase filtration efficiency similar to or beyond the control filters' efficiencies. However, it should be noted that this effect is not permanent, and filtration efficiencies dropped after exposure to high humidity as shown in YES ion, precon group. Hence, filtration efficiency after preconditioning should be taken as a conservative estimation of filter performance. In other words, a conservative range of filtration efficiencies at the most penetrating particle size could be estimated as: 64.8% to 87.2% for 30-minute MHI after ion treatment and 75.3 to 91.4% for 15-minute MHI after ion gun treatment. See Table 3 for filtration efficiency drop at the most penetrating particle size for MHI batch (30min), Table 4 for MHI separate (15 min), and Table 5 for 3M N95 8210 after 15-minute MHI.

TABLE 3
Most penetrating aerodynamic diameter and corresponding filtration
efficiency for MHI batch (30 min) after ion gun treatment

| | | | | MHI |
|---|---|---|---|---|
| | | MHI | MHI | batch |
| | | batch | batch | (30 min) |
| | | (30 min) | (30 min) | YES ion |
| | Control | NO ion | YES ion | Precon |
| Most Penetrating | 0.768 | 0.768 | 0.768 | 1.240 |
| Aerodynamic Diameter | | | | |
| (μm) | | | | |
| Filtration at Most | 86.3% | 78.3% | 87.2% | 64.8% |
| Penetrating Diameter | | | | |
| Efficiency Drop after | N/A | −8% | +0.9% | −21.5% |
| Single-cycle MHI | | | | |

TABLE 4
Most penetrating aerodynamic diameter and corresponding filtration
efficiency for MHI separate (15 min) after ion gun treatment

| | | | | MHI |
|---|---|---|---|---|
| | | MHI | MHI | separate |
| | | separate | separate | (15 min) |
| | | (15 min) | (15 min) | YES ion |
| | Control | NO ion | YES ion | Precon |
| Most Penetrating | 0.768 | 0.768 | 0.487 | 0.768 |
| Aerodynamic Diameter | | | | |
| (μm) | | | | |
| Filtration at Most | 86.3% | 81.4% | 91.4% | 75.3% |
| Penetrating Diameter | | | | |
| Efficiency Drop after | N/A | −4.9% | +5.1% | −11% |
| Single-cycle MHI | | | | |

TABLE 5
Most penetrating aerodynamic diameter and corresponding
filtration efficiency of 3M N95 8210 for MHI separate
(15 min) after ion gun treatment

| | | 3M 8210 | 3M 8210 |
|---|---|---|---|
| | | MHI | MHI |
| | | separate | separate |
| | 3M 8210 | (15 min) | (15 min) |
| | Control² | NO ion | YES ion |
| Most Penetrating | 0.018 | 0.121 | 0.073 |
| Aerodynamic Diameter | | | |
| (μm) | | | |
| Filtration at Most | 98.2% | 97.8% | 98.4% |
| Penetrating Diameter | | | |
| Efficiency Drop after | N/A | −0.4% | +0.2% |
| Single-cycle MHI | | | |

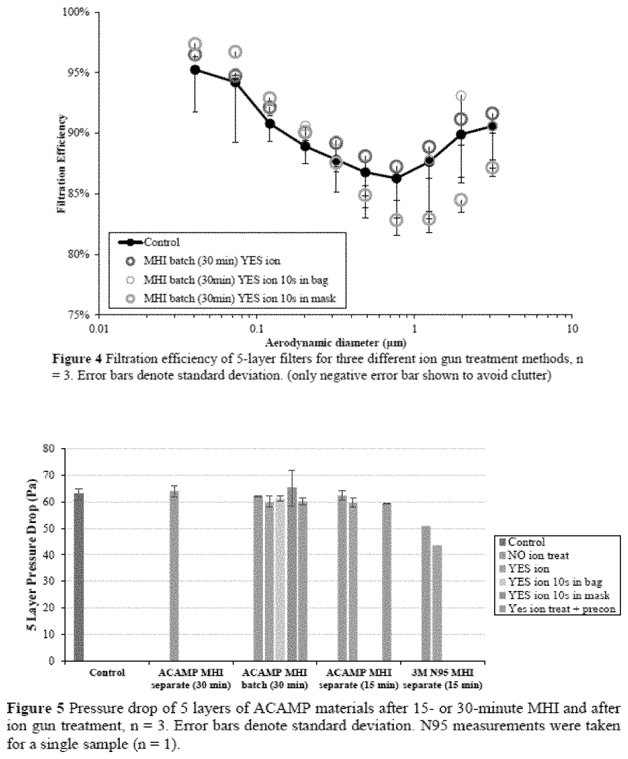

FIG. 4 summarizes filtration efficiencies measured for three different ion gun treatment methods described in the previous section Usage of Ion Gun. There is minimal difference between being bagged in anti-static bags after 30-second treatment and being contained in plastic bags after 10-second treatment. However, a 10-second ion treatment with the filter fitted into the mask was not as effective as the other methods. See Table 6 for the filtration efficiency drop at the most penetrating particle size for each type.

TABLE 6
Most penetrating aerodynamic diameter and corresponding filtration
efficiency for three different ion gun treatment methods

| | | | MHI | MHI |
|---|---|---|---|---|
| | | | batch | batch |
| | | MHI | (30 min) | (30 min) |
| | | batch | YES ion | YES ion |
| | | (30 min) | 10 s | 10 s |
| | Control | YES ion | in bag | in mask |
| Most Penetrating | 0.768 | 0.768 | 0.768 | 0.768 |
| Aerodynamic Diameter | | | | |
| (μm) | | | | |
| Filtration at Most | 86.3% | 87.2% | 87.3% | 82.8% |
| Penetrating Diameter | | | | |
| Efficiency Drop after | N/A | +0.9% | +1.0% | −3.5% |
| Single-cycle MHI | | | | |

As shown in FIG. 5, there was negligible change in pressure drop in all the scenarios presented.

Definitions and Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

References—the following references are indicative of the level of skill of a skilled artisan, and are incorporated herein by reference, in their entirety.
Mao, J., Grgic, B., Finlay, W. H., Kadla, J. and Kerekes, R. J. “Wood Pulp Based Filters for Removal of Sub-micrometer Aerosol Particles”, Nordic Pulp and Paper Research Journal 23 :420-425, 2008.
S. Tavernini, T. K. Church, D. A. Lewis, M. Noga, A. R. Martin, W. H. Finlay, “Deposition of Micrometer-sized Aerosol Particles in Neonatal Nasal Airway Replicas”, Aerosol Sci. Tech. 52:407-419, 2018.

1. A respirator or mask comprising filtration medium comprising at least one layer of a non-woven or knit fabric comprising a mix of natural and synthetic fibers.

2. The respirator or mask of claim 1, comprising two or more layers of fabric.

3. The respirator or mask of claim 1 wherein the natural fibers comprises cotton.

4. The respirator of claim 3 wherein the synthetic fibers comprises polyester.

5. The respirator or mask of claim 4 which is 50% cotton and 50% polyester.

6. The respirator or mask of claim 1 wherein the knit fabric is a fleece fabric.

7. A method of cleaning a respirator or mask, comprising the step of deionizing the respirator or mask.

8. The method of claim 7, wherein the respirator or mask is deionized with a mixture of random ions.

9. The method of claim 7, comprising a moist heat incubation (MHI) step prior to the deionization step.

10. The method of claim 9 wherein MHI is applied at a temperature of between about 40° C. to about 100° C., with relatively humidity in the range of about 60% to 100%.

11. The method of claim 7, wherein the respirator or mask comprises filtration medium comprising at least one layer of a non-woven or knit fabric comprising a mix of natural and synthetic fibers.
